(19) United States
(12) Patent Application Publication
(10) Pub. No.: US 2011/0159762 A1
(43) Pub. Date: Jun. 30, 2011

(54) PAPER MACHINE CLOTHING WITH MONOFILAMENTS HAVING CARBON NANOTUBES

(76) Inventors: Ashish Sen, Summerville, SC (US); Jürgen Abraham, Summerville, SC (US); Matthias Schmitt, Munchen (DE)

(21) Appl. No.: 12/976,674

(22) Filed: Dec. 22, 2010

Related U.S. Application Data
(60) Provisional application No. 61/291,467, filed on Dec. 31, 2009.

(51) Int. Cl. D03D 15/00; D02G 3/00; B29C 47/00; B82Y 99/00

(52) U.S. Cl. 442/202; 428/364; 428/401; 264/176.1; 977/742

(57) ABSTRACT

A PMC fabric yarn for use in a PMC fabric. The PMC fabric yarn has a composition which is a mixture of between 90% and 99.8% PET, with a remainder of said composition being between 0.2% and 10% CNT. The composition of the yarns has a relative elongation at 15.75 cN/tex which is between approximately 5% and 20% less than the PET, and an abrasion resistance which is between approximately 50% and 500% greater than the PET.

### CROSS REFERENCE TO RELATED APPLICATIONS

This is a non-provisional application based upon U.S. provisional patent application Ser. No. 61/291,467, entitled “PAPER MACHINE CLOTHING WITH MONOFILAMENTS HAVING CARBON NANOTUBES”, filed Dec. 31, 2009, which is incorporated herein by reference.

### BACKGROUND OF THE INVENTION

1. Field of the Invention

The present invention relates to paper machine clothing, and, more particularly, to the composition of monofilaments used in paper machine clothing.

2. Description of the Related Art

Paper machine clothing (PMC) fabrics are due to the applied tension prone to stretching, creep or elongation of the fabric.

Paper machines may have a tension roll to compensate for fabric creep; however, this tension roll can only compensate for a certain level of stretch in the fabric before the fabric needs to be prematurely removed due to the incapability of the paper machine to keep up with the stretch of the fabric.

In order to overcome this issue, more creep resistant materials making up the fabric are required to lower the fabric's tendency to elongate. Previous attempts to overcome this issue by replacing polyethylene terephthalate (PET) monofilaments with polyethylene naphthalate (PEN) failed due to the low abrasion resistance and the high tendency of the PEN yarns to fibrillate.

It is known to incorporate fillers such as carbon nanotubes (CNT) into polymers for reinforcing the polymers. For example, U.S. Pat. No. 6,331,265 discloses a method for producing CNT reinforced polymers. However, this method of compounding CNT with polymers is not commercially feasible because it involves dry mixing of a polymer, CNT and other additives using a high shear mixer. The '265 patent illustrates examples with polyolefin polymers, which are relatively more shear stable than polyesters and polyamides. In particular, polyesters degrade under high shear conditions and experience a reduction in polymer molecular weight, which decreases final tensile properties for the resulting reinforced polymer. On the other hand, decreasing the shear mixing rate minimizes polymer degradation but comprises the distribution of CNT within the polymer and reduces the improvement in mechanical properties.

What is needed in the art is a monofilament yarn for a PMC fabric that is less prone to creep when the fabric is under tension during use, and has good abrasion resistance.

### SUMMARY OF THE INVENTION

The present invention provides a PMC fabric with CNT reinforced monofilament yarns with a decreased elongation, less creep and improved stiffness and increased abrasion resistance. This material has a lower relative elongation than regular PET monofilaments but at the same time ensures a high fibrillation and abrasion resistance of the material.

The invention in one form is directed to a PMC fabric including a plurality of monofilament yarns, at least some of the yarns having a composition which is a mixture of between 90% and 99.8% PET, with a remainder of said composition being between 0.2% and 10% CNT. The composition of the yarns has a relative elongation at 15.75 cN/tex which is between approximately 5% and 20% less than the PET, and an abrasion resistance which is between approximately 50% and 500% greater than the PET.

The invention in another form is directed to a PMC fabric yarn for use in a PMC fabric. The PMC fabric yarn has a composition which is a mixture of between 90% and 99.8% PET, with a remainder of the composition being between 0.2% and 10% CNT. The composition of the yarns has a relative elongation at 15.75 cN/tex which is between approximately 5% and 20% less than the PET, and an abrasion resistance which is between approximately 50% and 500% greater than the PET.

The invention in yet another form is directed to a method of manufacturing a PMC fabric yarn for use in a PMC fabric. The method includes the steps of: compounding a polymeric mixture consisting essentially of a CNT premixture with a high intrinsic viscosity (IV), and a PET with a high IV, wherein the IV of each of the CNT premixture and the PET is greater than approximately 0.70; and forming the polymeric mixture into a monofilament PMC fabric yarn.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a fragmentary, perspective view of a portion of a fabric including an embodiment of a monofilament yarn of the present invention;

FIG. 2 is an enlarged, fragmentary, perspective view of a portion of a single monofilament yarn in the fabric of FIG. 1, illustrating CNT embedded within the yarn;

FIG. 3 is an enlarged perspective view of the CNT shown in FIG. 2, with the different layers of the CNT shown sequentially exposed; and

FIG. 4 is a flowchart illustrating an embodiment of the method of making monofilament yarns of the present invention.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

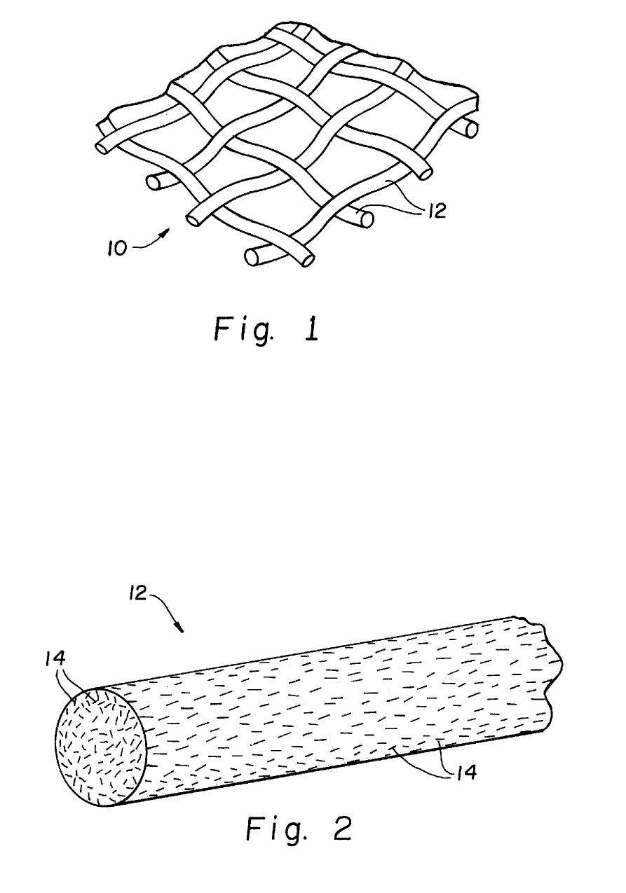

Referring now to the drawings, and more particularly to FIG. 1, there is shown a portion of an embodiment of a PMC fabric 10 including a plurality of woven monofilament yarns 12. The specific configuration of fabric 10 may vary, depending upon the application. For example, the specific weave pattern of fabric 10 may vary from one application to another. Moreover, fabric 10 need not necessarily be a woven fabric, but may include non-woven yarns 12.

At least some and preferably all of the yarns 12 making up fabric 10 have a composition which is a mixture of between 90% and 99.8% PET, with a remainder of the composition being between 0.2% and 10% CNT. Preferably, yarns 12 have a composition with between 0.7% and 4% CNT. Yarns 12 also have a diameter of between approximately 0.05 mm and 0.9 mm, but this may also vary between applications.

Yarns 12 have a composition as described above which provides a relative elongation at 15.75 cN/tex which is between approximately 5% and 20% less than the PET alone, preferably between approximately 10% to 15% less than PET alone. Moreover, yarns 12 have a composition with an abrasion resistance which is between approximately 50% to 500% greater than said PET alone, preferably between approximately 90% to 500% greater than said PET alone, and even more preferably approximately 90% greater than said PET alone.

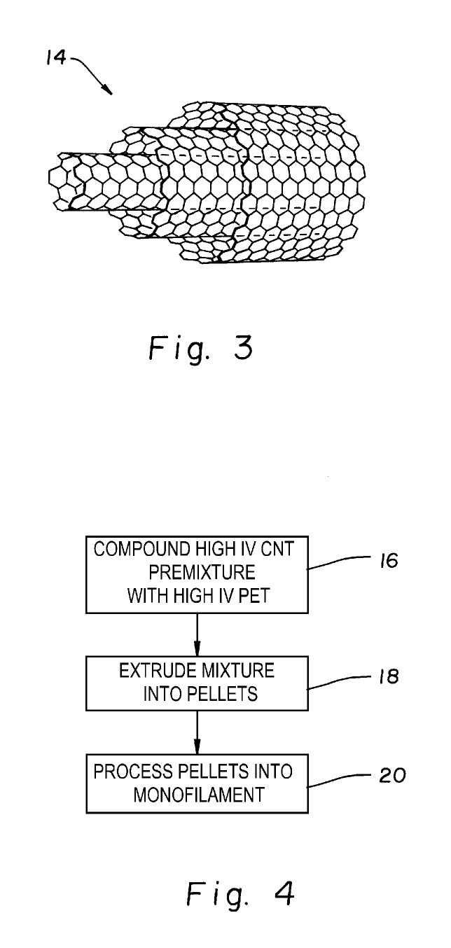

Referring now to FIG. 2, a yarn 12 is shown in greater detail, and include CNT 14 embedded within the PET base material. CNT 14 has an average length of approximately 10 microns. CNT 14 also has an average diameter of between approximately 5 and 20 nanometers, and preferably has an average diameter of approximately 13 nanometers. CNT 14 may be a single walled CNT or a multi-walled CNT. In the illustrated embodiment, CNT 14 is a multi-walled CNT, shown in more detail in FIG. 3 with the layers sequentially exposed for illustration purposes. The multiple nested and coaxially arranged walls making up each CNT provide the CNT with a greater tensile strength and abrasion resistance, compared with single walled CNT.

The incorporation of CNT into the PET matrix has been found to have a positive effect on the relative elongation of the yarn. A Masterbatch of a polymer material is a pre-mixture or concentrate which is let down in the final product. However, CNT masterbatches are only available with a low solution IV of the polymer, i.e., a low IV resin. (The intrinsic viscosity (IV) is used to measure the viscosity of a polymeric solution. The IV of a polymeric solution is related to the volume and molecular weight of the polymer.) The addition of this low IV resin to the commonly used high IV PET covers or masks the positive effect of the CNT resulting in an inferior yarn. Once the base resin of the CNT Masterbatch is changed to the same IV as used for the PET monofilament this masking effect is dramatically reduced thereby revealing a product with improved properties.

In one example, yarns 12 have a composition consisting essentially of a polymeric mixture with a CNT premixture having a high intrinsic IV, and a PET having a high IV. The IV of both the CNT premixture and the PET is greater than approximately 0.70, and preferably is between approximately 0.80 to 1.10.

Studying the yarn properties of the present invention has shown that with the addition of 0.2-10 wt. % CNT, the relative elongation of the material is not only decreased by at least 5%, but also it is possible to increase the tenacity and significantly increase the abrasion resistance and still keep other properties like shrinkage and shrink force.

An example of one type of carbon nanotube which may be mixed with PET and used with the present invention is Baytubes™, which is manufactured and sold by Bayer Materials. This particular carbon nanotube has an average length of approximately 10 microns. This particular carbon nanotube also has an average diameter of between approximately 5 nm to 20 nm, preferably approximately 13 nm.

### Example 1

The following tables, Tables 1 and 2, show some of the physical properties of PET monofilaments used for PMC weaving, Table 1, and some of the process conditions used to produce the monofilaments in Example 1, Table 2. The pure PET control is shown in the first column and the further columns show the change in properties by the addition of different amounts of CNT, at concentration levels of 0.7% and 4.0%.

TABLE 1
Physical properties for Example 1 monofilaments

| | | 99.3% PET | 96.0% PET |
|---|---|---|---|
| Monofilament formulation | 100% PET | 0.7% CNT | 4% CNT |
| TEX [g/m] | 37 | 38 | 48 |
| Break Strength [N] | 20.5 | 24.5 | 22.8 |
| Tenacity [cN/tex] | 55.6 | 64.5 | 47.6 |
| Toughness [in * gf/den in] | 0.451 | 0.455 | 0.481 |
| Young's Modulus [cN/tex] | 1147 | 1236 | 1227 |
| Elongation @ Break (%) | 11 | 10 | 12 |
| Elongation @ 15.75 cN/tex [%] | 1.4 | 1.2 | 1.25 |
| Knot Strength [cN/tex] | 27 | 29 | 30 |
| Loop Strength [cN/tex] | 31 | 29 | 32 |
| Hot air Shrink @ 140 C. [%] | 9.6 | 8.7 | 7.5 |
| Maximum Shrink Force [cN/tex] | 5.674 | 6.531 | 4.43 |
| Abrasion Cycles to break | 5400 | 10,150 | |
| Electrical Conductivity | 4.8E11 | 4.3E11 | 2.9E6 |
| (Resistance, Ohms) | | | |

TABLE 2
Process conditions used to produce Example 1 monofilaments

| | | 99.3% PET |
|---|---|---|
| Resin | 100% PET | 0.7% CNT |
| Yarn Diameter (mm) | 0.18 | 0.18 |
| Spinneret (mm) | 0.900 | 0.900 |
| Spin Pump (cc/rev) | 20 | 20 |
| Quench Tank (F.) | 130 | 130 |
| Extruder zone-(F.) | 565 | 565 |
| Die (F) | 570 | 570 |
| Draw 1 | 130 | 130 |
| Draw 2 | 194 | 194 |
| Draw 3 | 200 | 201 |
| Pressure control | 1500 | 1500 |
| speed spin-pump (rpm) | 18.6 | 18.6 |
| Air gap | 2.5 | 2.5 |
| Draw 1 | 4.40 | 4.50 |
| Draw 2 | 1.20 | 1.30 |
| Draw 3 | 1.00 | 1.00 |

### Example 2

The following table, Table 3, shows some of the physical properties of PET monofilaments at two diameters used for PMC weaving. The pure PET controls are shown in the first and third columns and PET fibers with 0.8% CNT are shown in the second and fourth columns. Similar process conditions were used for each monofilament sample shown in Table 3.

TABLE 3
Physical properties for Example 2 monofilaments at 0.12 and
0.24 mm diameters

| Monofilament | 100% | 99.2% PET | 100% | 99.2% PET |
|---|---|---|---|---|
| formulation | PET | 0.8% CNT | PET | 0.8% CNT |
| Diameter (mm) | 0.12 | 0.12 | 0.24 | 0.24 |
| Modulus (cN/tex) | 1042 | 1130 | 962 | 1201 |
| Shrinkage (176 C./3 min) | 10.3 | 10.6 | 13.2 | 13.1 |
| Strain @ 15.75 | 1.52 | 1.45 | 1.67 | 1.5 |
| (cN/tex) (%) | | | | |
| Elongation (%) | 15.5 | 12.8 | 11.5 | 8.6 |
| Tenacity (cN/tex) | 60 | 63 | 64 | 63 |

From the foregoing examples, it is apparent that physical properties of the CNT reinforced monofilaments are improved with the present invention.

During manufacture of PMC fabric yarn 12, a compounding process is used to minimize PET degradation and thus maintain yarn properties. U.S. Pat. No. 6,331,265 described above uses mixing methods with either a high shear mixing method (which degrades PET) or adding CNT with the monomer before polymerization (which is not possible with the monofilament process of the present invention). The compounding process of the present invention feeds high IV PET resin and a high IV CNT premixture into a twin screw extruder to produce pellets (FIG. 4, blocks 16 and 18). The pellets are then used as a Masterbatch in the monofilament process (block 20).

Although one method to increase the IV of the CNT premixture is described above in the immediately preceding paragraph, another method to increase the IV of the CNT premixture is by utilizing extrusion equipment, such as a solid state extruder, which increases resin IV by reorienting the polymer.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A paper machine clothing (PMC) fabric including a plurality of monofilament yarns, at least some of said yarns having a composition which is a mixture of between 90% and 99.8% polyethylene terephthalate (PET), with a remainder of said composition being between 0.2% and 10% carbon nanotubes (CNT), and wherein said composition has a relative elongation at 15.75 cN/tex which is between approximately 5% and 20% less than said PET and an abrasion resistance which is between approximately 50% and 500% greater than said PET.

2. The PMC fabric of claim 1, wherein said composition has a relative elongation at 15.75 cN/tex which is between approximately 10% and 15% less than said PET.

3. The PMC fabric of claim 1, wherein said composition has an abrasion resistance which is between approximately 90% and 500% greater than said PET.

4. The PMC fabric of claim 1, wherein said composition has an abrasion resistance which is approximately 90% greater than said PET.

5. The PMC fabric of claim 1, wherein said composition includes between 0.5% and 4% CNT.

6. The PMC fabric of claim 1, wherein said composition is comprised of a polymeric mixture consisting essentially of a carbon nanotube (CNT) premixture with a high intrinsic viscosity (IV), and a polyethylene terephthalate (PET) with a high IV, wherein the IV of each of said CNT premixture and said PET is greater than approximately 0.70.

7. The PMC fabric of claim 6, wherein the IV of each of said CNT premixture and said PET is between approximately 0.80 to 1.10.

8. The PMC fabric of claim 1, wherein said CNT has an average length of approximately 10 microns, and an average diameter of between approximately 5 and 20 nanometers.

9. The PMC fabric of claim 8, wherein said CNT has an average diameter of approximately 13 nanometers.

10. The PMC fabric of claim 1, wherein said CNT is a multi-walled CNT.

11. The PMC fabric of claim 1, wherein said yarns have a diameter of between approximately 0.05 mm and 0.9 mm.

12. The PMC fabric of claim 1, wherein said PMC fabric includes a plurality of woven yarns.

13. A paper machine clothing (PMC) fabric yarn for use in a PMC fabric, said PMC yarn having a composition which is a mixture of between 90% and 99.8% polyethylene terephthalate (PET), with a remainder of said composition being between 0.2% and 10% carbon nanotubes (CNT), and wherein said composition has a relative elongation at 15.75 cN/tex which is between approximately 5% and 20% less than said PET, and an abrasion resistance which is between approximately 50% and 500% greater than said PET.

14. The PMC fabric yarn of claim 13, wherein said composition has a relative elongation at 15.75 cN/tex which is between approximately 10% and 15% less than said PET.

15. The PMC fabric yarn of claim 13, wherein said composition has an abrasion resistance which is between approximately 90% and 500% greater than said PET.

16. The PMC fabric yarn of claim 13, wherein said composition has an abrasion resistance which is approximately 90% greater than said PET.

17. The PMC fabric yarn of claim 13, wherein said composition includes between 0.5% and 4% CNT.

18. The PMC fabric yarn of claim 13, wherein said composition is comprised of a polymeric mixture consisting essentially of a carbon nanotube (CNT) premixture with a high intrinsic viscosity (IV), and a polyethylene terephthalate (PET) with a high IV, wherein the IV of each of said CNT premixture and said PET is greater than approximately 0.70.

19. The PMC fabric yarn of claim 18, wherein the IV of each of said CNT premixture and said PET is between approximately 0.80 to 1.10.

20. The PMC fabric yarn of claim 13, wherein said CNT has an average length of approximately 10 microns, and an average diameter of between approximately 5 and 20 nanometers.

21. The PMC fabric yarn of claim 20, wherein said CNT has an average diameter of approximately 13 nanometers.

22. The PMC fabric yarn of claim 13, wherein said CNT is a multi-walled CNT.

23. The PMC fabric yarn of claim 13, wherein said yarns have a diameter of between approximately 0.05 mm and 0.9 mm.

24. The PMC fabric yarn of claim 13, wherein said PMC fabric includes a plurality of woven yarns.

25. A method of manufacturing a paper machine clothing (PMC) fabric yarn for use in a PMC fabric, said method comprising the steps of:
compounding a polymeric mixture consisting essentially of a carbon nanotube (CNT) premixture with a high intrinsic viscosity (IV), and a polyethylene terephthalate (PET) with a high IV, wherein the IV of each of said CNT premixture and said PET is greater than approximately 0.70; and
forming the polymeric mixture into a monofilament PMC fabric yarn.

26. The method of manufacturing a PMC fabric yarn of claim 25, wherein the IV of each of said CNT premixture and said PET is between approximately 0.80 to 1.10.

27. The method of manufacturing a PMC fabric yarn of claim 25, including the step of extruding the polymeric mixture into pellets used in said forming step.
